(19) United States
(12) Patent Application Publication
(10) Pub. No.: US 2024/0278711 A1
(43) Pub. Date: Aug. 22, 2024

(54) Headlight for a Motor Vehicle

(71) Applicant: Bayerische Motoren Werke Aktiengesellschaft, Muenchen (DE)

(72) Inventors: Sebastien CASENAVE, Muenchen (DE); Rene UEBLER, Muenchen (DE); Abhishek VENKATESAN, Muenchen (DE)

(21) Appl. No.: 18/567,819

(22) PCT Filed: Jul. 29, 2022
(86) PCT No.: PCT/EP2022/071297

§ 371 Date: Dec. 7, 2023

(30) Foreign Application Priority Data
Aug. 25, 2021 (DE) 10 2021 121 949.3

(51) Int. Cl. B60Q 1/14; F21S 41/143; F21S 41/151; F21S 41/663

(52) U.S. Cl. CPC B60Q 1/1423; F21S 41/143; F21S 41/151; F21S 41/663; B60Q 2300/112

(57) ABSTRACT

A headlight for a motor vehicle includes a first lighting device and a second lighting device, which are provided for generating a dipped beam. The first lighting device, when switched on, generates a first light distribution on the ground in front of the motor vehicle, and the second lighting device, when switched on, generates a second light distribution on the ground in front of the motor vehicle. The first lighting device is permanently switched on when the dipped beam is activated, and the second lighting device is switched off when the dipped beam is activated and when a predetermined condition is met. The second lighting device is always switched from being switched off to being switched on when the speed of the motor vehicle is greater than or equal to a specified speed threshold.

### BACKGROUND AND SUMMARY

The invention relates to a headlight for a motor vehicle and a corresponding motor vehicle.

Headlights for motor vehicles are known from the prior art, which generate a low beam light having reduced range (so-called town light) under certain conditions. The town light is typically switched on when the motor vehicle drives at lower velocity within a developed area.

The town light is conventionally activated in that the low beam light, which is generated using one or more illumination devices of the headlight, is dimmed. This does result in a shorter range of the low beam light, but has the disadvantage that the front field immediately before the front of the motor vehicle is also illuminated less strongly.

The object of the invention is to provide a headlight for a motor vehicle having an improved, dynamically adaptable low beam light function.

This object is achieved by the headlight according to the claimed invention.

The headlight according to embodiments of the invention is provided for a motor vehicle. The motor vehicle can be, for example, a passenger vehicle and possibly also a utility vehicle. When interactions between the headlight and components of the motor vehicle are described hereinafter and in particular in the claims, this is always to be understood to mean that the interaction occurs upon arrangement or installation of the headlight in the motor vehicle. The components of the headlight which have a corresponding interaction with the motor vehicle or components of the motor vehicle are therefore designed such that the interaction is induced upon arrangement or installation of the headlight in the motor vehicle.

The headlight according to embodiments of the invention comprises a first illumination device and a second illumination device, which are provided for generating a low beam light. The headlight is therefore a front headlight of the motor vehicle, since the low beam light is generated in the direction of travel in front of the motor vehicle. The first illumination device of the headlight according to embodiments of the invention generates a first light distribution on the ground in front of the motor vehicle in the switched-on state. Similarly, the second illumination device generates a second light distribution on the ground in front of the motor vehicle in the switched-on state.

The headlight according to embodiments of the invention is designed such that the first illumination device is permanently in the switched-on state when the low beam light is activated, whereas the second illumination device is in the switched-off state when the low beam light is activated and a predetermined condition is met and otherwise (i.e., when the low beam light is activated and the predetermined condition is not met) is in the switched-off state. The second illumination device is switched here from the switched-off state into the switched-on state whenever the velocity of the motor vehicle is greater than or greater than or equal to a predetermined velocity threshold. The term “whenever” expresses that the condition that the velocity of the motor vehicle is greater than or greater than or equal to the predetermined velocity threshold is a sufficient condition for switching on a previously switched-off second illumination device.

For the above-described switching on or switching off of the first and second illumination device, a corresponding control device, which effectuates these switching processes, is assigned to the headlight. The control device reads out the velocity detected by the motor vehicle here in order to effectuate the corresponding switching on of the second illumination device if the predetermined velocity threshold is exceeded. It is essential according to embodiments of the invention here that a low beam light having reduced brightness is not achieved by dimming illumination devices, but rather in that one of two illumination devices (the second illumination device) is not switched on. The brightness of the light distribution of the first illumination device can therefore remain unchanged in the case of a low beam light having reduced brightness, so that good illumination is still ensured using the low beam light.

In one preferred embodiment, the above predetermined condition, in which the second illumination device remains in the switched-off state when the low beam light is activated, is met when the motor vehicle is located in a developed area and the velocity of the motor vehicle is less than or less than or equal to the predetermined velocity threshold. In this way, a so-called town light can be implemented using the headlight according to embodiments of the invention, because a low beam light having reduced brightness is always generated when the motor vehicle drives at lower velocity in a developed area. To implement this embodiment, vehicle data are evaluated by the headlight or a device assigned to the headlight which, in addition to the velocity of the motor vehicle, also include the information as to whether the motor vehicle is located in a developed area. This information can be obtained, for example, from the navigation system of the motor vehicle.

Depending on the design, the above predetermined velocity threshold can be defined differently. The velocity threshold is preferably between 50 km/h and 70 km/h and particularly preferably is 60 km/h.

In a further, particularly preferred embodiment, the first illumination device is designed such that in the switched-on state, it generates the first light distribution in a first ground area directly adjoining the front of the motor vehicle. In other words, the first illumination device is used to generate a front field illumination in the direct vicinity of the front of the motor vehicle. In contrast, the second illumination device is designed such that in the switched-on state, it generates the second light distribution in a second ground area which is spaced apart from the front of the motor vehicle, wherein the range of the second light distribution is greater than the range of the first light distribution. The second light distribution therefore represents a range component of the low beam light which is only required, however, at higher velocities of the motor vehicle or outside developed areas.

In a further preferred embodiment, the first illumination device comprises one or more illumination units, which each comprise a plurality of light sources, preferably LEDs, and a plurality of imaging optical units, preferably lenses, and a light-transmissive intermediate lens. The intermediate lens is preferably formed from plastic. The term “light-transmissive” is to be understood such that the intermediate lens has a transmittance of 90% or more and in particular essentially 100% for the light of the light sources. Each light source is assigned a separate imaging optical unit, by which the light of the respective light source is imaged on the ground in front of the motor vehicle, wherein the light of the respective light source passes through the intermediate lens after passing through the assigned imaging optical unit.

Using the above-described embodiment, an appealing design of the corresponding illumination units can be achieved similar to the design of a daytime running light. The intermediate lens is preferably inclined here in relation to the plane which extends perpendicularly to the vehicle longitudinal direction.

In a further preferred embodiment, the intermediate lens, in a top view of the headlight, forms a contour made up of one or more straight and/or curved sections. For example, the contour can comprise one or more bars and/or curved lines and/or an L shape and/or a U shape and/or any other shapes. In this way, a particularly appealing appearance is achieved for the illumination units of the first illumination device.

Modules known per se can be used for the second illumination device, which are currently already used for generating the low beam light. Such modules are preferably also used for generating the high beam light. In one preferred variant, the second illumination device contains one or more projection modules, which each generate at least a part of the second light distribution by projection of light generated in the projection module, and/or one or more reflection modules, which each generate at least a part of the second light distribution by reflection of light generated in the reflection module. A corresponding projection module has a suitable projection optical unit here, whereas a reflection module contains one or more reflectors, such as free-form reflectors. Furthermore, a light source, for example, in the form of one or more LEDs and/or laser diodes, is also provided in a projection module or reflection module.

In a further preferred embodiment, the headlight according to the invention comprises a third illumination device, which generates a daytime running light in the switched-on state. The third illumination device preferably contains one or more illumination units, which each comprise a thick-walled optical unit known per se, into which corresponding light is radiated at its rear side, which results in illumination of the front side of the thick-walled optical unit and generation of the daytime running light in this way.

In addition to the above-described headlight, the invention relates to a motor vehicle which comprises one or more of the headlights according to embodiments of the invention.

An exemplary embodiment of the invention will be described in more detail hereinafter on the basis of the appended figures.

### BRIEF DESCRIPTION OF THE DRAWINGS

FIG. 1 shows a schematic illustration of a detail of the front of a motor vehicle, in which two headlights according to one embodiment of the invention are installed.

FIG. 2 shows a sectional view along line L-L of FIG. 1, which schematically shows the structure of an illumination unit associated with the first illumination device.

FIG. 3 shows a perspective illustration which illustrates the generation of the low beam light by the headlights from FIG. 1 on the ground in front of the motor vehicle.

### DETAILED DESCRIPTION OF THE DRAWINGS

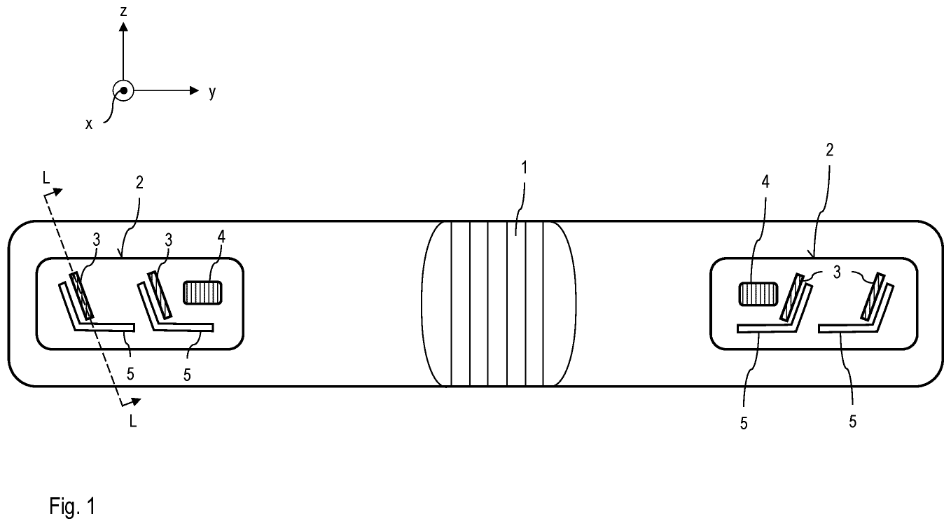

The front of a motor vehicle having a radiator grill 1 arranged in the middle and two outer headlights 2 is illustrated in a detail in the illustration of FIG. 1. Furthermore, FIG. 1 shows a Cartesian coordinate system, in which the x axis corresponds to the vehicle longitudinal direction, the y axis represents the vehicle transverse direction, and the z axis represents the vertical direction of the motor vehicle. The two headlights 2 are identically constructed and each comprise a projection module 4 known per se in the inner region, using which in one operating mode a part of the low beam light is generated and using which in another operating mode the high beam light is generated. The projection module 4 comprises a number of light sources, which are implemented as LEDs, for example, and a projection optical unit, using which a light distribution on the ground in front of the motor vehicle is generated from the light of the light sources, as will be explained in more detail hereinafter. The projection module 4 represents a second illumination device in the meaning of the patent claims.

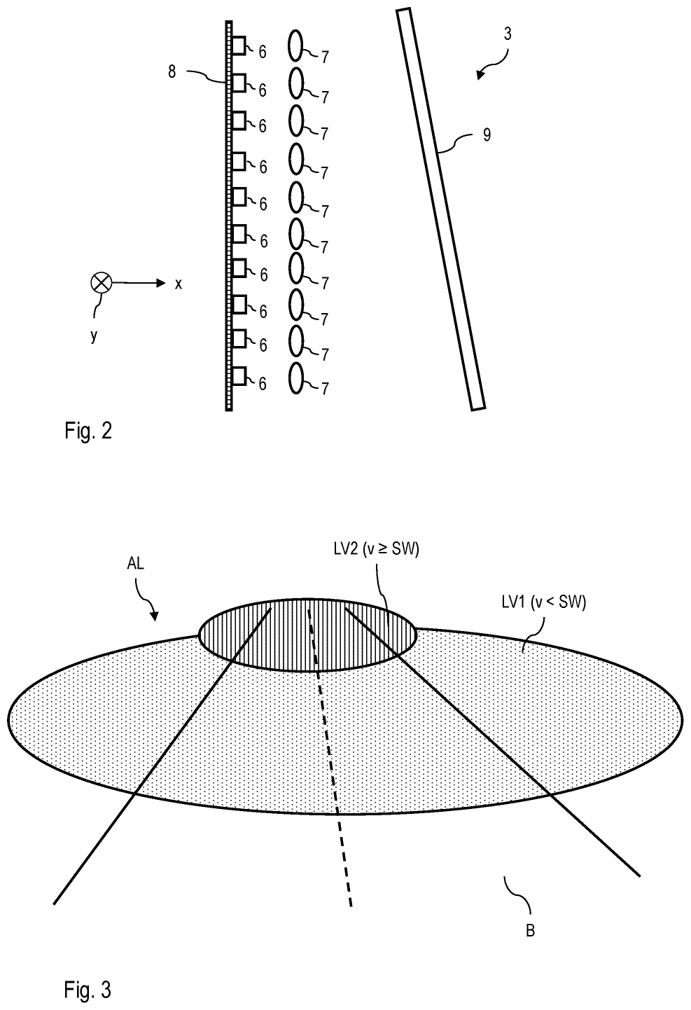

In addition to the projection module 4, two illumination units 3 are installed in the respective headlight, which together form a first illumination device in the meaning of the claims. Upon activation, the two illumination units 3 appear as illuminated bars, which are indicated by a shading in FIG. 1. The precise structure of the illumination units 3 will be explained hereinafter on the basis of FIG. 2. Two further illumination units 5 are provided adjacent to each illumination unit 3 in the respective headlight, which are designed in the top view of FIG. 1 as an L-shaped contour, which illuminates upon activation of the respective illumination unit. The illumination units 5 contain thick-walled optical units known per se, which have the L-shaped contour in the top view of FIG. 1 in the exemplary embodiment shown here. This contour forms the front side of a light-transmissive plastic component, which forms the thick-walled optical unit and has a thickness of several centimeters in the x direction. Light is radiated into this thick-walled optical unit at its rear side via a suitable illumination device, such as one or more LEDs or an optical fiber, which then exits at the front side of the thick-walled optical unit and generates the illuminated L-shaped contour in this way.

One essential feature of the embodiment described here is that the low beam light is generated situationally only by way of the illumination units 3 or by the combination of the illumination units 3 with the projection module 4. In this case, the illumination units 3 are used to generate a so-called town light, i.e., a low beam light having reduced brightness and range. This town light consists of a so-called front field illumination on the ground directly in front of the front of the motor vehicle and represents a low beam light having reduced range, which is always switched on when the motor vehicle drives at a velocity below a velocity threshold in a developed area, wherein the velocity threshold is preferably 60 km/h. In contrast, the projection module 4 generates a light distribution on the ground in front of the motor vehicle which is spaced apart from its front and has a greater range than the town light. The corresponding light distributions which are generated by the illumination units 3 or the projection module 4 are illustrated once again in FIG. 3.

FIG. 3 shows a perspective illustration from the viewing direction of the driver of the motor vehicle, the front of which is shown in FIG. 1. The ground B in front of the motor vehicle in the form of a straight road can be seen here. Furthermore, two light distributions LV1 and LV2 are shown, which are cast on the ground B by the headlights 2 from FIG. 1 and are used to generate the low beam light AL. With activated low beam light, in any case the illumination units 3 are switched on independently of the location of the motor vehicle and its velocity. These illumination units generate the light distribution LV1, which is cast on the ground directly adjoining the front of the motor vehicle and represents a front field illumination in the direct vicinity of the motor vehicle. In contrast, the light distribution LV2 is generated by the projection modules 4 of the headlights 2.

The light distribution LV1 is used as the town light, i.e., exclusively this light distribution is generated when the motor vehicle drives within a developed area at a velocity v less than the above-mentioned velocity threshold SW. A control device assigned to the headlights 2 inputs, on the one hand, the current travel velocity of the motor vehicle and, on the other hand, the information obtained from navigation data of the motor vehicle as to whether the motor vehicle is driving in an urban or rural area. If it should be established that the motor vehicle drives in an urban area at a velocity less than the velocity threshold SW, only the light distribution LV1 is switched on as the town light. In contrast, if the motor vehicle should drive at a velocity v less than the threshold value SW, but is located outside a developed area, in addition to the light distribution LV1, the light distribution LV2 is generated by activating the projection modules 4 of the headlights 2.

The light distribution LV2 represents the range component of the low beam light AL which is required outside developed areas due to low ambient brightness. In addition, the range component according to the light distribution LV2 is also always generated when the velocity v of the motor vehicle is greater than or equal to the velocity threshold SW, independently of whether the motor vehicle is driving in an urban or rural area. In this way, a sufficient illumination of the ground or the road in front of the motor vehicle at higher velocities is ensured by way of the low beam light AL. As soon the vehicle velocity drops below the velocity threshold SW again and the motor vehicle furthermore is driving in an urban area, the projection modules 4 are switched off again, so that the low beam light AL again only consists of the town light in the form of the light distribution LV1.

FIG. 2 shows a section along line L-L of FIG. 1 in order to illustrate the structure of a corresponding illumination unit 3 for generating the town light. The illumination unit 3 comprises a plurality of light sources 6 in the form of LEDs, which emit white light in operation and are arranged on a common circuit board 8. Each LED 6 is assigned an imaging optical unit 7 in the form of a lens, which images the light of the associated LED on the ground in front of the motor vehicle. The light which has passed the imaging optical units 7 goes here through a light-transmissive intermediate lens 9, which has the form of a bar and is shown shaded in FIG. 1. The intermediate lens 9 consists of plastic and is significantly thinner in comparison to the thick-walled optical unit, which is used for the illumination units 5 of the daytime running light. Its thickness is in the range of a few millimeters, in particular between 2 mm and 3 mm.

In one preferred variant, a plurality of micro-optical units, by which the imaging on the ground in front of the motor vehicle is improved, are provided on the inside of the intermediate lens 9 facing toward the imaging optical units 7. Such micro-optical units are preferably also provided on the inside of the thick-walled optical unit of the respective illumination units 5.

As is apparent from FIG. 2, the intermediate lens 9 is inclined in relation to the plane which extends perpendicularly to the longitudinal direction x of the motor vehicle. An appealing design of the illumination units 3 is achieved in this way. The front sides of the thick-walled optical units of the illumination units 5 are typically also inclined, so that the appearance of the illumination units 3 and 5 is similar, which is desirable for reasons of design.

The embodiments of the invention described above have an array of advantages. In particular, a dynamic low beam light function is ensured by two illumination devices in a simple manner, wherein illumination having greater range is only effectuated as needed by switching on one of the illumination devices. As soon as this greater range is no longer required, only a reduced low beam light in the form of a town light is generated by one of the illumination devices. The illumination device which generates the town light preferably forms a contour in the top view of the motor vehicle, by which an appearance similar to a daytime running light can be achieved. This illumination device preferably furthermore contains inclined intermediate lenses, by which a design similar to thick-walled optical units is achieved, which are often used to generate daytime running light.

### LIST OF REFERENCE SIGNS

1 radiator grill
2 headlight
3 first illumination device, illumination unit for town light
4 second illumination device, projection module
5 third illumination device, illumination unit for daytime running light
6 LEDs
7 imaging optical units
8 circuit board
9 intermediate lens
x, y, z spatial directions
AL low beam light
LV1 first light distribution for front field illumination in the low beam light
LV2 second light distribution as a range component of the low beam light
B ground in front of the motor vehicle
V velocity of the motor vehicle
SW velocity threshold

1.-10. (canceled)

11. A headlight for a motor vehicle, the headlight comprising:
a first illumination device; and
a second illumination device, wherein:
the first illumination device and the second illumination device are configured to generate a low beam light,
the first illumination device, in a switched-on state, generates a first light distribution on a ground in front of the motor vehicle and the second illumination device, in the switched-on state, generates a second light distribution on the ground in front of the motor vehicle,
the first illumination device is permanently in the switched-on state when the low beam light is activated,
the second illumination device is in a switched-off state when the low beam light is activated and a predetermined condition is met, and
the second illumination device is always switched into the switched-on state from the switched-off state when a velocity of the motor vehicle is greater than or greater than or equal to a predetermined velocity threshold.

12. The headlight according to claim 11, wherein the predetermined condition is met when the motor vehicle is in a developed area and the velocity of the motor vehicle is less than or less than or equal to the predetermined velocity threshold.

13. The headlight according to claim 11, wherein the predetermined velocity threshold is between 50 km/h and 70 km/h.

14. The headlight according to claim 13, wherein the predetermined velocity threshold is 60 km/h.

15. The headlight according to claim 11, wherein:
the first illumination device is configured such that, in the switched-on state, the first illumination device generates the first light distribution in a first ground area directly adjacent to a front of the motor vehicle,
the second illumination device is configured such that, in the switched-on state, the second illumination device generates the second light distribution in a second ground area, which is spaced apart from the front of the motor vehicle, and
a range of the second light distribution is greater than a range of the first light distribution.

16. The headlight according to claim 11, wherein:
the first illumination device comprises one or more illumination units, which each comprise a plurality of light sources and a plurality of imaging optical units and a light-transmissive intermediate lens,
each light source is assigned a separate imaging optical unit, by which light of the respective light source is imaged on the ground in front of the motor vehicle, and
the light of the respective light source passes through the intermediate lens after passing through the assigned imaging optical unit.

17. The headlight according to claim 16, wherein the intermediate lens is inclined in relation to a plane which extends perpendicularly to a vehicle longitudinal axis.

18. The headlight according to claim 16, wherein the intermediate lens, in a top view of the headlight, forms a contour made up of one or more straight and/or curved sections.

19. The headlight according to claim 11, wherein the second illumination device contains one or more projection modules, which each generate at least a part of the second light distribution by projection of light generated in the respective projection module, and/or comprises one or more reflection modules, which each generate at least a part of the second light distribution by reflection of light generated in the respective reflection module.

20. The headlight according to claim 11, further comprising:
a third illumination device, which generates a daytime running light in the switched-on state.

21. A motor vehicle comprising the headlight according claim 11.
